(19) United States
(12) Patent Application Publication
(10) Pub. No.: US 2019/0169907 A1
(43) Pub. Date: Jun. 6, 2019

(54) Swing Door Control Linkage

(71) Applicant: Magna Closures Inc., Newmarket (CA)

(72) Inventors: Jube Raymond LEONARD, Barrie (CA); Joseph SCHEURING, Richmond Hill (CA)

(21) Appl. No.: 16/200,777

(22) Filed: Nov. 27, 2018

Related U.S. Application Data
(60) Provisional application No. 62/590,733, filed on Nov. 27, 2017.

(51) Int. Cl. E05F 11/34; E05F 11/54

(52) U.S. Cl. CPC E05F 11/34; E05F 15/622; E05F 11/54

(57) ABSTRACT

A linear actuator assembly for a closure panel of a vehicle comprising: a linear actuator for mounting in an interior of a frame of the closure panel and having an extensible member for extending through an aperture in the frame, the extensible member configured for extension and retraction with respect to the interior along a linear axis of the linear actuator, the frame having the aperture on a shut face; a sealing member for positioning on the shut face adjacent to the extensible member for inhibiting foreign matter from entering the interior from an exterior of the frame, the sealing member inhibiting lateral movement of the extensible member with respect to the linear axis; and a linkage operationally first connecting at one end to the extensible member and for operationally second connecting at another end to a body of the vehicle adjacent to the closure panel, such that both the one end and the another end are located externally to the interior of the frame being both to one side of the aperture.

### CROSS REFERENCE TO RELATED APPLICATIONS

This application claims priority from U.S. Provisional Patent Application No. 62/590,733, filed on Nov. 27, 2017; the entire contents of which are hereby incorporated by reference herein.

### FIELD

The present disclosure relates to closure panel actuation systems.

### BACKGROUND

When a spindle (electric linear actuator) is used to actuate (e.g. open/close) a door/lift gate, there can be a distance between a hinge centerline of the door/lift gate and an axis of the spindle. This distance can be referred to as a “Moment Arm”. Due to the kinematics, there can be an inherent increase and decrease of the moment arm during swing of the door/lift gate. This change in moment arm can create a number of problem areas, such as 1) packaging space for the linear actuator does not allow for the increase and decrease in the moment arm and/or 2) at a given point of the door/lift gate travel, the inherent moment arm can be too much or too little for balancing of the kinematics. As such, current linear actuators can be used in presentment functions of vehicle doors or lift gates, however packaging and/or kinematics balancing difficulties can be encountered. Further, in terms of current state of the art linear actuator systems, normally the end of the spindle is directly and fixedly connected to the vehicle frame. However, due to the offset point of rotation of the door about the hinges, relative to this fixed connection point, the spindle is typically allowed to have some lateral play (e.g. pivotal) in its movement internal to the door, in order for the door not to jam. However, a further disadvantage is realized in that in order to accommodate this lateral play, an access port through the door frame (from which the spindle extends) must be provided as larger than a diameter of the spindle. As a consequence, this enlarged access port needs to have a seal that accounts for this allowed lateral movement, which can become an undesirable maintenance item due to age/wear. Also, dedicated internal space within the door cavity must be provided in order to provide for the lateral movement of current spindle designs. In particular, on narrow doors, this lateral movement can lead to jamming or intrusion as discussed in U.S. Pat. No. 9,174,517, which shows a relationship between the hinges and the spindle connection with the door. In U.S. Pat. No. 9,174,517, the spindle body is allowed to move laterally (e.g. pivot) within the door cavity. If it were not for this allowance for lateral movement, the spindle movement would be limited by the side door (or by other means) at some point along its axis, which would result in binding during opening or closing of the door.

Further, US20170292310 describes a different solution to the same problem. There is a member that is provided within the actuator, however, the actuator housing has to be enlarged to accommodate for lateral movement of this member within the housing. Also, there can be an issue of sealing the port in the door frame where the member has to move. As well, support for the lead screw of the actuator is at a distal nut portion further within the door interior, i.e. interior to the shut face of the door.

### SUMMARY

It is an object of the present invention to provide linear actuator systems to obviate or mitigate at least some of the above-presented disadvantages.

It is a further object to provide linear actuator systems to control the increase and decrease of an inherent moment arm or to otherwise make it constant throughout the door/lift gate travel.

In an embodiment, there is provided a linear actuator assembly for a closure panel of a vehicle comprising: a linear actuator for mounting in an interior of a frame of the closure panel and having an extensible member for extending through an aperture in the frame, the extensible member configured for extension and retraction with respect to the interior along a linear axis of the linear actuator, the frame having the aperture on a shut face; a sealing member for positioning on the shut face adjacent to the extensible member for inhibiting foreign matter from entering the interior from an exterior of the frame, the sealing member inhibiting lateral movement of the extensible member with respect to the linear axis; and a linkage operationally first connecting at one end to the extensible member and for operationally second connecting at another end to a body of the vehicle adjacent to the closure panel, such that both the one end and the another end are located externally to the interior of the frame being both to one side of the aperture.

A second aspect provided is a method for operating a linear actuator assembly for a closure panel of a vehicle, the linear actuator assembly having a linear actuator for mounting in an interior of a frame of the closure panel and having an extensible member for extending through an aperture in the frame, the extensible member configured for extension and retraction with respect to the interior along a linear axis of the linear actuator and having a sealing member between the aperture and the extensible member, the method including the steps of: extending the extensible member through the aperture in the frame and along the linear axis in order to position to closure panel from the closed position towards the open position; inhibiting lateral movement of the extensible member by the sealing member with respect to the linear axis; while the extensible member being extended, a linkage operationally first pivots at one end and also operationally second pivots at another end, the linkage coupled to the extensible member at the one end and coupled to the body at the another end; wherein both the one end and the another end are located externally to the interior of the frame and are both to one side of the aperture.

In a further aspect provided is a linear actuator assembly for a closure panel of a vehicle comprising: a linear actuator for mounting in an interior of a body of the vehicle and having an extensible member for extending through an aperture in the body, the extensible member configured for extension and retraction with respect to the interior along a linear axis of the linear actuator, the body having the aperture opposite a shut face of a frame of the closure panel; a sealing member for positioning on the body adjacent to the extensible member for inhibiting foreign matter from entering the interior from an exterior of the body, the sealing member inhibiting lateral movement of the extensible member with respect to the linear axis; and a linkage operationally first connecting at one end to the extensible member and for operationally second connecting at another end to the frame, such that both the one end and the another end are located externally to the interior of the body being both to one side of the aperture.

### BRIEF DESCRIPTION OF THE DRAWINGS

The foregoing and other aspects will now be described by way of example only with reference to the attached drawings, in which:

FIG. 1 is a perspective view of a vehicle closure panel coupled to a vehicle;

FIG. 2 is a further embodiment of the closure panel shown in FIG. 1;

FIG. 3 is a cross sectional view of an embodiment of a linear actuator assembly shown in FIG. 1, in a closed position;

FIG. 4 is a cross sectional view of the linear actuator assembly shown in FIG. 3 in an open position;

FIG. 5 is a perspective view of a further embodiment of the linear actuator assembly shown in FIG. 3, in a partially open position;

FIG. 6 is a perspective view of the linear actuator assembly shown in FIG. 5, in an open position;

FIG. 7 is a top view of the linear actuator assembly shown in FIG. 5, in a closed position;

FIG. 8 shows a perspective view of the linear actuator assembly shown in FIG. 7;

FIG. 9 shows a plan view of the linear actuator assembly shown in FIG. 3;

FIG. 10 shows a further embodiment of the linear actuator assembly shown in FIG. 3;

FIG. 11 shows a cut away view of an example linear actuator of FIG. 3;

FIG. 12 is a cross sectional view of a further embodiment of the example linear actuator of FIG. 11; and

FIG. 13 is a method of operation of the linear actuator assembly of FIG. 3;

FIG. 14 is an inner partial perspective view of a prior art vehicle door illustrating the lateral play of a spindle within an aperture provided on the vehicle door shut face and the inner panel;

FIG. 15 is an exploded view of an embodiment of a linear actuator assembly in accordance with an illustrative embodiment;

FIG. 16 is a cross-sectional perspective view take along the line A-A of FIG. 1, illustrating the linear actuator assembly fixedly mounted within the vehicle door along a linear axis relative to the vehicle door;

FIG. 17 is an enlarged cross-sectional perspective view of FIG. 16, in accordance with an illustrative embodiment;

FIG. 18 is an enlarged cross-sectional top view of FIG. 15 take along the line A-A of FIG. 1, with the vehicle door in a closed position, in accordance with an illustrative embodiment;

FIG. 19 is a cross-sectional top view of FIG. 15 take along the line A-A of FIG. 1, with the vehicle door in a closed position, in accordance with an illustrative embodiment;

FIG. 20 is a cross-sectional top view of FIG. 15 take along the line A-A of FIG. 1, with the vehicle door in a partially open position, in accordance with an illustrative embodiment;

FIG. 21 is a cross-sectional top view of FIG. 15 take along the line A-A of FIG. 1, with the vehicle door in another partially open position, in accordance with an illustrative embodiment;

FIG. 22 is a cross-sectional top view of FIG. 15 take along the line A-A of FIG. 1, with the vehicle door in another partially open position, in accordance with an illustrative embodiment;

FIG. 23 is a cross-sectional top view of FIG. 15 take along the line A-A of FIG. 1, with the vehicle door in a fully open position, in accordance with an illustrative embodiment;

FIG. 24 is a diagrammatic view of the prior art swing door of FIG. 14, illustrating the lateral play of the spindle pivotally fixed to the vehicle body at a constant position relative to the vehicle body;

FIG. 25 is a diagrammatic view of the linear actuator assembly of FIG. 3, illustratively showing the variable pivot point of a fixedly mounted linear actuator relative to the vehicle closure panel, in accordance with an illustrative embodiment; and

FIGS. 26 to 28 illustrate a sequence of states of a linear actuator assembly, in accordance with another illustrative embodiment, during a vehicle door moving between a closed position and an open position.

### DETAILED DESCRIPTION

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

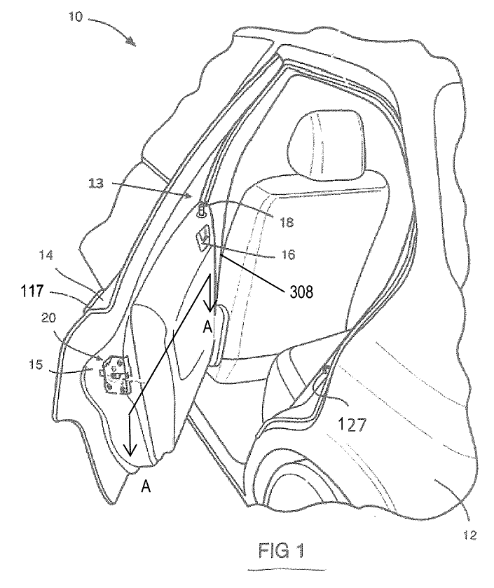

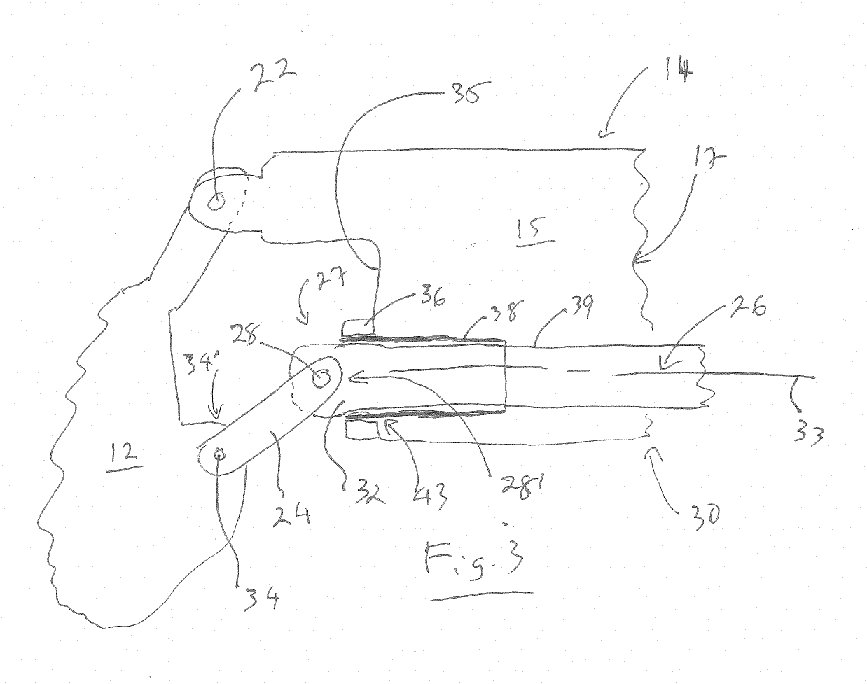

FIG. 1 is a perspective view of a vehicle 10 that includes a vehicle body 12 and at least one vehicle door 14 (also referred to as a closure panel 14). The vehicle closure panel 14 includes a latch 20 that is positioned on a frame 15 of the vehicle closure panel 14, the latch 20 being releasably engageable with a striker 127 on the vehicle body 12 to releasably hold the vehicle closure panel 14 in a closed position. The frame 15 also supports a window 13 via a window regulator assembly mounted to the frame 15 of the vehicle closure panel 14. An outside closure panel handle 117 can be provided for opening the latch 20 (i.e. for releasing the latch 20 from the striker 127) to open the vehicle closure panel 14, as well as to optionally operate an (electrically powered) linear actuator assembly 30 (see FIG. 3). For example, the linear actuator assembly 30 can be used in presentment functions of the closure panel 14. Further, the vehicle closure panel 14 can have inside controls 16, 18 (e.g. door handle, door locking/unlocking tab, etc.) for operating the latch 20 and the electric linear actuator assembly 30. It is also recognized that a key fob (not shown) or other presence sending controls (e.g. door presence sensor—not shown) can be used to activate the electric linear actuator assembly 30, as desired.

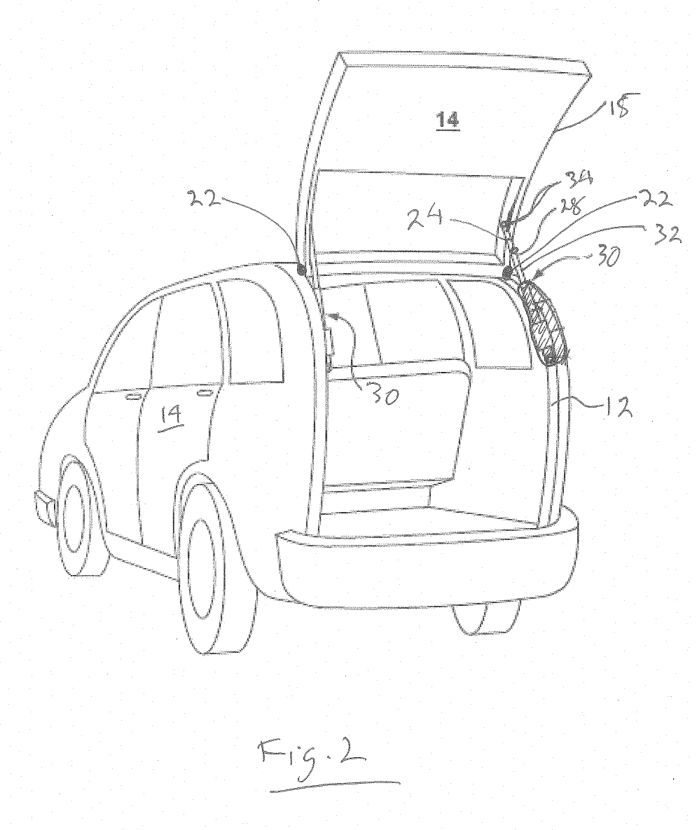

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate (see FIG. 2), or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the vehicle body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the vehicle body 12 of the vehicle at the front, side or back of the door, as the application permits. It is recognized that the vehicle body 12 can be represented as a body panel of the vehicle 10, a frame of the vehicle 10, and/or a combination frame and body panel assembly, as desired. As such, the linear actuator assembly 30 can be used in conjunction with a number of closure panel 14 types, including swing types (e.g. hinged) and/or slide types (e.g. tracked).

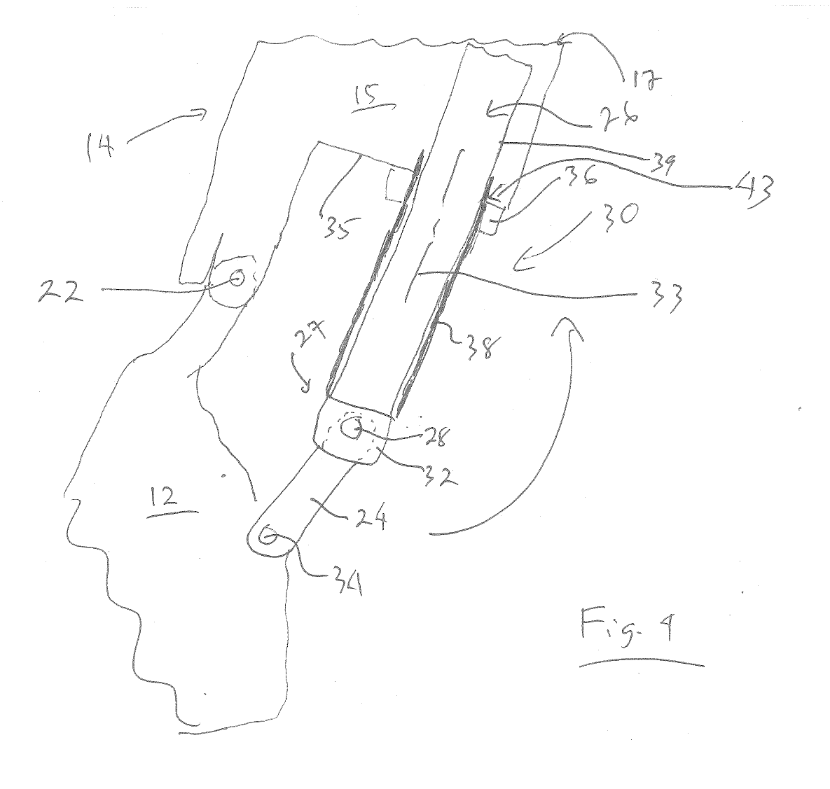

The closure panel 14 (e.g. occupant ingress or egress controlling panels such as but not limited to vehicle doors and lift gates/hatches) can be connected to the vehicle body 12 via one or more hinges 22 (see FIGS. 2,3,4,5,6,7) and the latch assembly 20 (e.g. for retaining the closure panel 14 in a closed position once closed). It is also recognized the hinge 22 can be configured as a biased hinge 22 that can be configured to bias the closure panel 14 towards the open position (shown in FIGS. 4,6) and/or towards the closed position (shown in FIGS. 4,7). In terms of a biased hinge 22, used in combination with the linear actuator assembly 30, the biased hinge 22 can provide for assistance in presenting the closure panel 14 beyond where a ratchet of the latch assembly 20 can influence positioning of the closure panel 14 (i.e. via operation of linear actuator assembly 30 as further described below). It is also recognized that the biased hinge 22 can be configured as a door check mechanism integrated into the hinge and/or an independent door check assembly providing the bias. Since the linear actuator assembly 30 is positionable at a location traditionally associated with a door check arrangement (i.e. located between hinges 22 and between the vehicle body 12 and the closure panel 14), such door checks may be eliminated and replaced with the linear actuator assembly 30 which may be configured with mechanical or electromechanical detent/checking features.

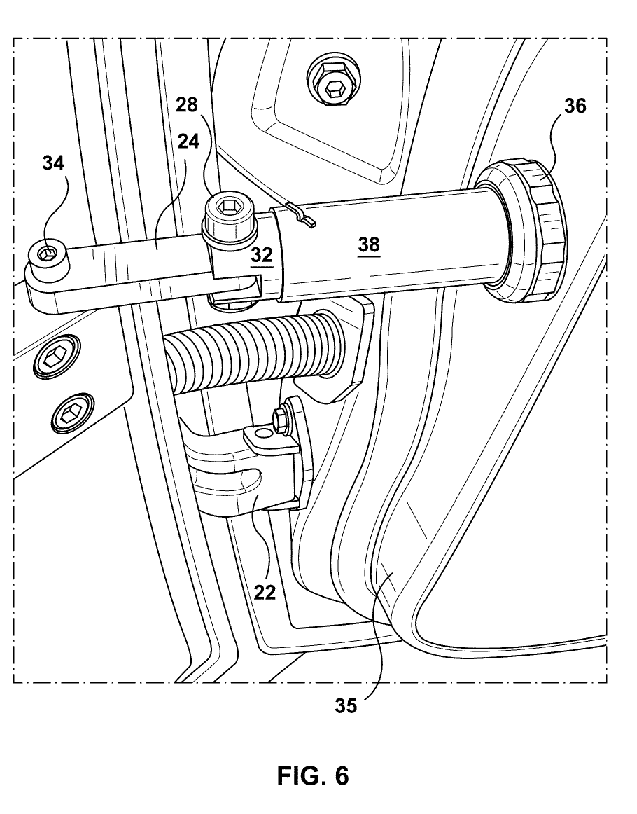

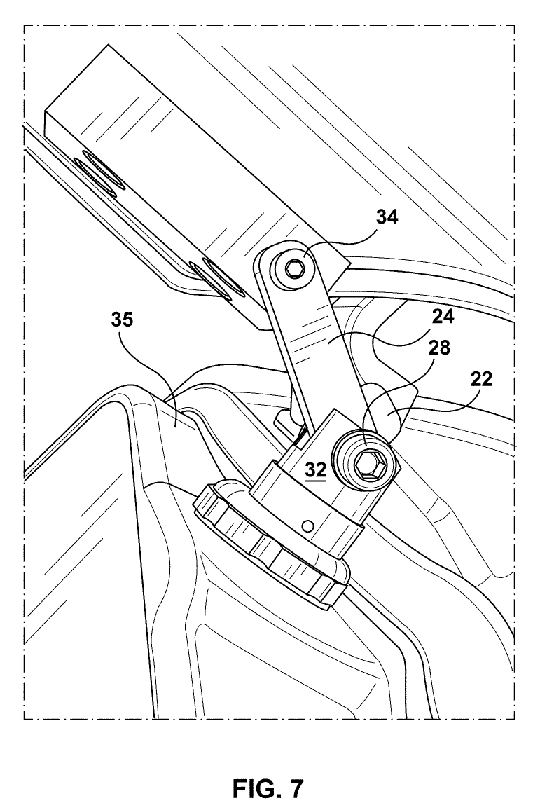

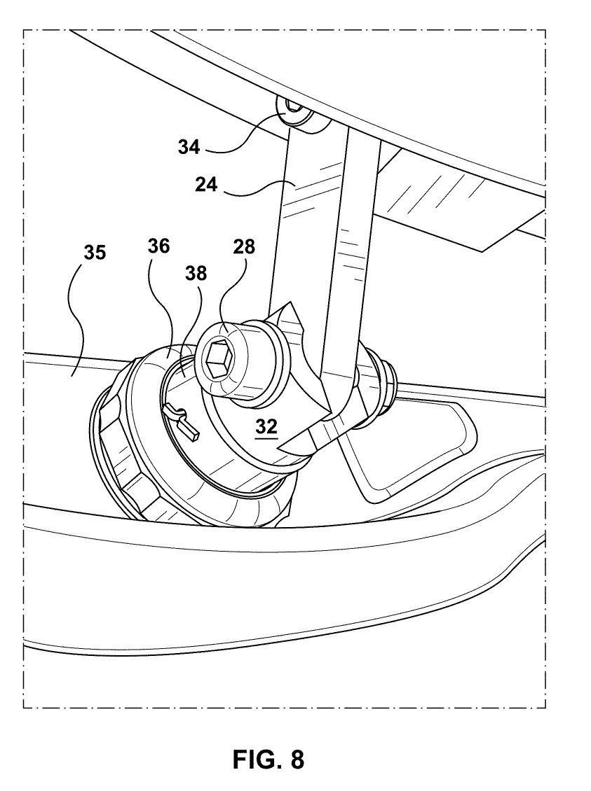

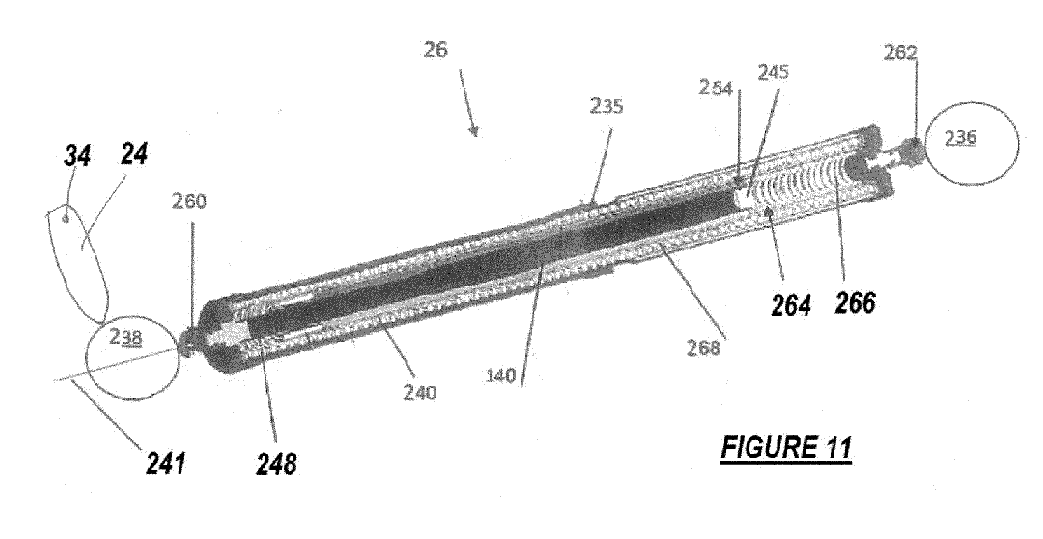

Referring to FIGS. 3 and 8, shown is one embodiment of the linear actuator assembly 30, also referred to as a swing door linear actuator assembly 30, for power opening/closing of the closure panel 14 (e.g. door). The linear actuator assembly 30 includes a linkage 24 interconnecting an (extensible) end 27 of an (e.g. door) actuator 26 (e.g. spindle/lead screw based actuator, for example—see FIGS. 11,12) between the door frame 15 and the vehicle body 12 (e.g. A or B pillar). The linkage 24 can be connected at one end by a pivot point 28 (e.g. location 28) to an extendible member 32 of the actuator 26 (see FIG. 11) and at another end by a pivot point 34 (e.g. location 34) to the vehicle body 12. Illustratively, the linkage 24 shown in FIG. 3 is a linear member, but other configurations, such as an L-shaped member or arcuate shaped member, are possible depending on the pivotal nature of the closure panel 14 (i.e. position of hinges relative to mounting points of the linkage 24 and the packaging space available). It is recognized that both of the pivot points 28,34, as well as a body of the linkage 24 there-between, are positioned exterior to an interior 17 of the door frame 15. A sealing member 36 is positioned about a periphery of the extendible member 32 and adjacent to the door frame 15 (i.e. on a shut face 35 of the door frame 15 external to the door interior 17), so as to inhibit the inclusion of foreign matter (e.g. dirt, water, etc.) from penetrating from the exterior environment to the interior of the door frame 15. Further, an optional housing cover 38 of the extensible member 32 can be used to support the extensible member 32 at a location on the exterior of the door frame shut face 35, as positioned between the sealing member 36 and the extensible member 32. As shown in comparison between FIGS. 3 and 4 and between FIGS. 6 and 7, noted is the extension and retraction (see FIGS. 6 and 7) of the housing cover 38 into and out of the door interior 17 via relative movement between the housing cover 38 and the sealing member 36, as compared to the operation shown in FIGS. 3 and 4 in that there is no relative movement between the housing cover 38 and the sealing member 36. It is recognized that the housing cover 38 could be coupled to an exterior 39 of the extensible member 32, so that the housing cover 38 and the extensible member 32 extend and retract together (with respect to the door interior 17) along a fixed linear axis 33 of the linear actuator assembly 30. The door face 35 contains an aperture 43 through which the extensile member 32 extends and retracts with respect to an interior 17 of the door frame 15. It is recognized that the pivot points 28,34 can also be referred to as pivots 28,34, as desired. The sealing member 36 can include a seal such as an 0-Ring, supported within the aperture 43 an into engagement with housing cover 38 or extensible member 32, for example by employing a threaded ring coupling positioned within the aperture 43, which acts to support extensible member 32 and/or extensible member 32 within the aperture 43 to prevent lateral play.

Thus, as shown in FIGS. 3 and 8, the (mounting) pivot points 28,34 can be more distributed compared to prior art linear actuators having one pivotal mounting point within the door interior 17 (i.e. between the door panels). As such, the presented linear actuator assembly 30 provides for the linkage 24 positioned wholly externally to the door interior 17 (including the two pivot points 28,34 at either end of the linkage 24). This external positioning of the pivot points 28,34 (at either end of the linkage 24) provides for the extensible member 32 (at the end 27) of the actuator 26 to extend rather than swing relative to the door frame 15, as opposed to have the entire actuator swing as is known in the art). As a result, it is advantageous for the linear actuator assembly 30 to have the extensible member 32 (e.g. spindle) fixed (i.e. inhibited from pivoting laterally with respect to the linear axis 33) within the door interior 17 as the door moves between the open and closed position.

One benefit of the linear actuator assembly 30 is that a slimmer closure panel 14 can be provided (or allow more room for other components with in the door interior 17), as compared to those systems allowing for pivoting within the door frame interior 17, since space to allow for pivotal movement of the extensible member 32 within the door interior 17 doesn't have to be accounted for due to the presence of the linkage 24 with the pair of pivot points 28,34.

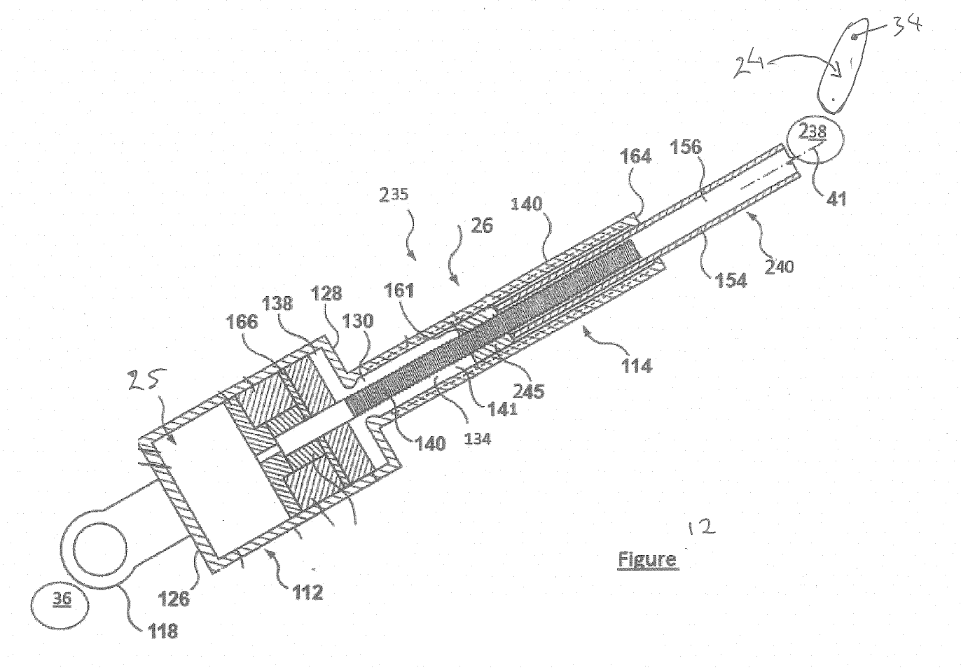

Further, since the end of the extensible member 32 adjacent to the shut door face 35 does not move laterally with respect to the linear axis 33, sealing via the sealing member 36 between the door and the spindle can be more easily made (i.e. a simpler seal, less chance of wearing out etc.). Further, since a moment arm of the linear actuator assembly 30 can be provided as constant, as compared to those systems allowing for pivoting within the door frame interior 17, the motor 25 (see FIG. 12) of the linear actuator assembly 30 would not have to compensate for increases in torque for smaller arms. As well, the linear actuator assembly 30 can be more easily balanced thus providing a system with balanced kinematics, as compared to those systems allowing for pivoting within the door interior 17. For example, the motor 25 may be operated at a constant output as part of such a balanced system (not having to overcome any increases/decreases in the moment arm), with less variations in motor speed/torque being required during an opening or closing operation (not having to adjust for speed increase/decrease as a result in changes to the moment arm). As a result, less complex motor control can be required, as well as being able to provide a motor 25 that is optimized and smaller, less noisy, and a smoother door opening/closing user experience can be provided.

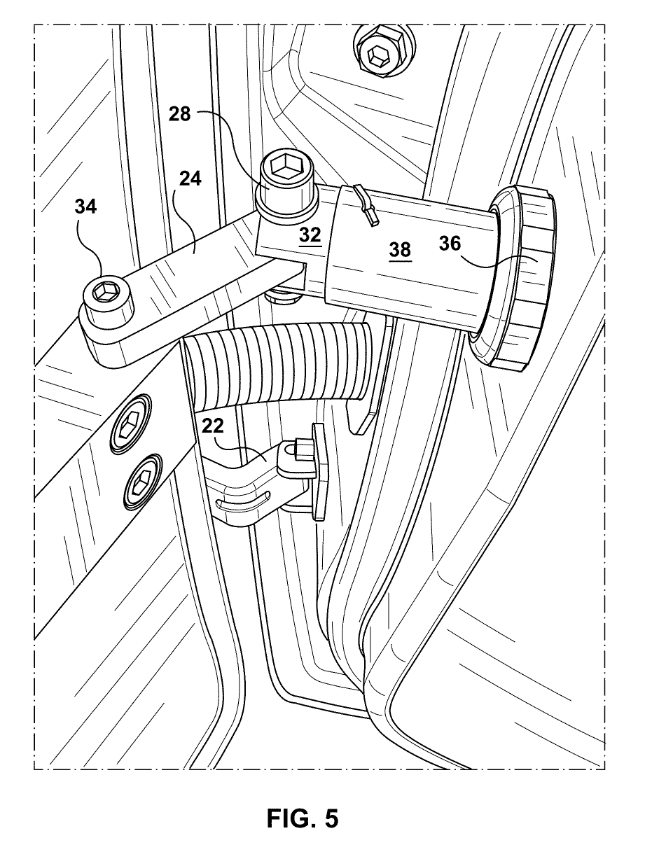

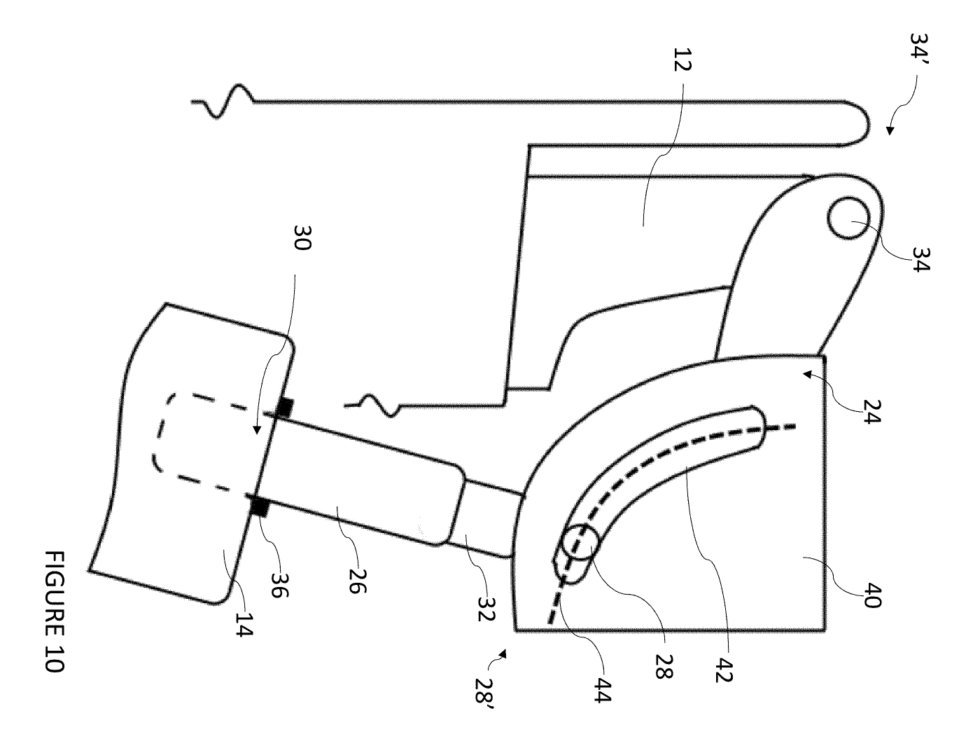

It is recognized that FIGS. 3 and 4 (and associated FIGS. 5-9) describe the embodiment of the linear actuator assembly 30 having the linkage 24 that rotates around the pivot point 28 fixed on the extensible member 32 as well as the pivot point 34 fixed on the vehicle body 12. In this manner, the linear actuator assembly 30 for the closure panel 14 includes: the linear actuator assembly 30 for mounting in the interior 17 of the door frame 15 and has an extensible member 32 for extending through the aperture 43 in the door frame 15, the extensible member 32 configured for extension and retraction with respect to the interior 17 along the linear axis 33 of the linear actuator assembly 30, the door frame 15 having the aperture 43 on the shut face 35; the sealing member 36 for positioning on the shut face 35 adjacent to the extensible member 32 for inhibiting foreign matter from entering the interior 17 from an exterior of the door frame 15, the sealing member 36 inhibiting lateral movement of the extensible member 32 with respect to the linear axis 33; and the linkage 24 operationally connected at one end 28′ to the extensible member 32 and for operationally connecting at another end 34′ to the vehicle body 12 adjacent to the vehicle closure panel 14, such that both the one end 28′ and the another end 38′ are both located externally to the interior 17 of the door frame 15 to one side of the aperture 43. For example, the operationally connected (e.g. at the end 34′) is pivotally connected at a first pivot point 34 and the operationally connecting (e.g. at end 28′) is pivotally connected at a second pivot point 28. Alternatively, the operationally connected (e.g. at end 34′) is pivotally connected at a first pivot point 34 and the operationally connecting (e.g. at end 28′) is connected at a second pivot point 28 configured for translational movement along a track 42 of the linkage 24 (see FIG. 10). In an embodiment, the sealing member 36 may only restrict lateral play of the extensible member 32 without sealing the interior 37, such as for example when the aperture 43 is provided on the dry side (e.g. not exposed to exterior road conditions and elements) of the vehicle door 14.

Referring to FIG. 10, an alternative embodiment of the linear actuator assembly 30 is shown, such that the linkage 24 includes a plate 40 having the track 42 therein, in which pivot 28 translates along a translation axis 44 (e.g. arcuate) of the track 42. As the extensible member 32 is connected at one end to the pivot 28 (e.g. pin connection), the extensible member 32 follows the path (i.e. translation axis 44) of the track 42 to provide for the moment arm to remain (e.g. the same) over the swing of the closure panel 14. For example, the pivot 28 can be fitted with a roller to follow the track 42. It is recognized that in the embodiment described in FIG. 10, end 34′ can include both translation as well as rotation (i.e. pivoting).

FIGS. 11 and 12 show an example configuration for the (e.g. linear) actuator 26 of FIG. 3, for example a spring loaded strut 26. A housing 235 also contains an extension member 240 (e.g. extensible member 32) used to extend from, or retract within, the housing 235 to effect the resulting location of the closure panel 14 with respect to the door frame 15. For example, an extended extension member 240 results in positioning the closure panel 14 in the extended state (see FIG. 4), while a retracted extension member 240 results in positioning the closure panel 14 in a retracted state (see FIG. 3) with respect to the door frame 15. It is recognized that the linear actuator 26 can be implemented as a strut (see FIG. 12 as an example type of strut). The linear actuator 26 can be of a biasing type (e.g. spring and/or gas charge supplying the bias). In one example, see FIG. 12, the extension member 240 is actively driven by via a lead screw 140. The extension member 240 is either extended from, or retracted into, the housing 235. It is recognized that the linear actuator 26 can have the lead screw 140 (e.g. rotary output member—see FIG. 12) operated actively (i.e. driven) by the motor 25 (e.g. electrical).

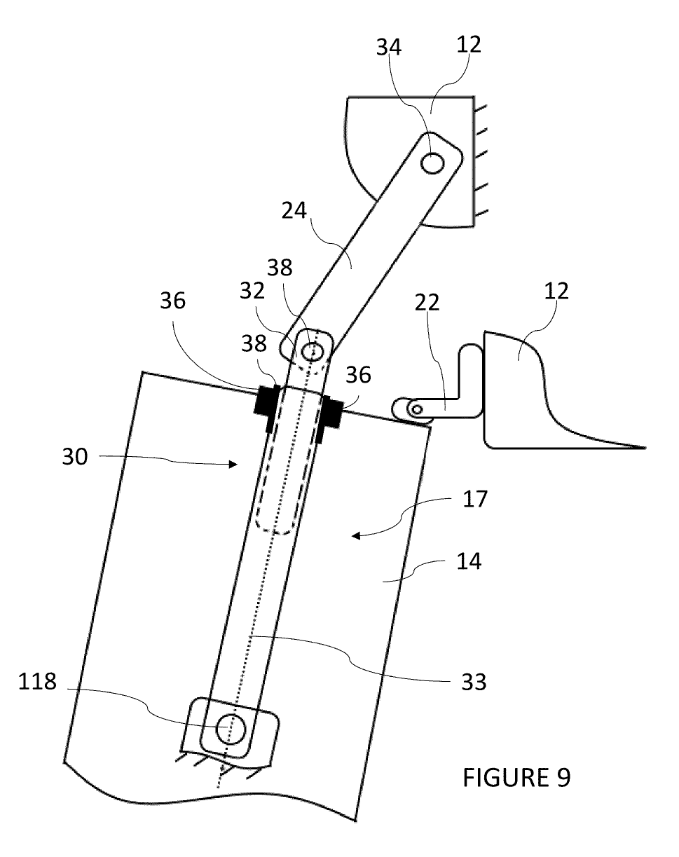

Referring to FIGS. 3, 11, 12, shown is the linear actuator 26 with the housing 235 having a first end 260 for connecting to the linkage 24 via pivot point 28 (e.g. point 238) and a second end 262 for connecting to the closure panel 14 at fixed mount 118 (see FIG. 9), also referred to by reference numeral 236. In this configuration, the linear actuator 26, by example only, has the extension member 240 (e.g. a stator member slideably engageable with a rotary output member such as via mated threads) positioned in an interior 264 of the housing 235. A distal end of 254 the extension member 240 is coupled to the second end 262 (for example via an optional element 266—spring) and the proximal end 248 of the extension member 240 is coupled to the first end 260. The extension member 240 is coupled to the lead screw 140 via a travel member 245 (for example as an integral part of or separate to the extension member 240), such that rotation of the lead screw 140 causes travel of the travel member 245 along the lead screw 140, to result in extension or retraction of the extension member 240 with respect to the housing 235. As discussed in relation to FIG. 12, the travel member 245 and the lead screw 140 are coupled to one another via mated threads. As shown, the linear actuator 26 can be a strut having a resilient element of the power spring 268 for providing the counterbalance torque (T) during operation of the closure panel 14 in moving between the extended and retracted positions (see FIGS. 3 and 4).

Referring again to FIGS. 11, 12, the travel member 245 is positioned at one end of the extension member 240. The extension member 240 is coupled (in this example case via a mounted kicker spring 266) to the housing 235 at the distal end. Complimentary, the extension member 240 is coupled to the linkage 24 at the first (e.g. proximal) end 260. As such, as the extension member 240 is displaced along the longitudinal axis 241 (e.g. linear axis 33—see FIG. 3), the attached travel member 245 is displaced along the lead screw 140. As such, as the closure panel 14 is moved between the extended and retracted positions (see FIGS. 3, 4), the position of the travel member 245 along the lead screw 140 varies, thereby providing for reciprocation of the travel member 245 along the longitudinal axis 241 of the lead screw 140 and thus resulting extension and retraction of the extension member 240 with respect to the housing 235.

Referring now to FIG. 12, the embodiment of the linear actuator 26 is shown including the housing 235 having a lower housing 112 and an upper housing 114 for containing the extension member 240 (e.g. extensible shaft/rod). Fixed mount 118 is attached to an end wall 126 of lower housing 112 proximal to the door frame 15. Upper housing 114 provides a (e.g. cylindrical) sidewall 141 defining a chamber 134 that is open at both ends. A distal end wall 128 of lower housing 112 includes an aperture 130. The lead screw 140 (or referred to as a lead screw 140 or rotary output member powered by rotary motion of the motor 25) which can be used to transport or otherwise guide the travel member 245 (connected to the extension member 240) along the longitudinal axis 41 (i.e. similar to linear axis 33 of FIG. 3). For example, the travel member 245 contains an internally facing series of threads in bore 161 that are mated to an externally facing series of threads on the extension member 240, as desired. Extensible member 240 provides a cylindrical sidewall 154 defining a chamber 156 and can be concentrically mounted between upper housing 114 and lead screw 140. As described earlier, pivot mount 238 (i.e. pivot point 28) is attached to the distal end of extensible member 240 at the linkage 24. The nut 245 (also referred to as the travel member 245) is mounted around the proximal end of extensible member 240 relative to lower housing 112 and is coupled with lead screw 140 in order to convert the rotational movement of lead screw 140 into the linear motion of the extensible member 240 along the longitudinal axis 41 of lead screw 140. The nut 245 can include splines that extend into opposing coaxial slots provided on the inside of upper housing 114 to inhibit nut 245 from rotating as the nut 245 travels along the longitudinal axis 41. Alternatively, the nut 245 may be configured without the splines and thus be free to rotate as the nut 245 travels along the longitudinal axis 41, without departing from the scope of the description. An integrally-formed outer lip 164 in upper housing 114 can provide an environmental seal between chamber 134 and the outside.

A spring housing 138 can be provided in lower housing 112 and defined by cylindrical sidewall 122, end wall 128, and a flange 166. Within spring housing 138, a power spring (not shown in FIG. 12) similar to the power spring 268 as seen in FIG. 11 can be optionally coiled around lead screw 140, providing a mechanical counterbalance to the weight of the closure panel 14. One end of power spring 268 is positioned or otherwise attached to the travel member 245 and the other is secured to a portion of cylindrical sidewall 122. When extensible member 240 is in its retracted position, power spring 268 is tightly coiled around lead screw 140 and therefore applies bias against the travel member 245. As lead screw 140 rotates to extend extensible member 240, in concert with travel of the travel member 245 along the upper housing 114, power spring 268 uncoils, releasing its stored energy and transmitting an axial force through extensible member 240. When power screw 140 rotates to retract extensible member 240, in concert with travel of the travel member 245 along the upper housing 114, power spring 268 recharges by recoiling around lead screw 140. Also shown in FIG. 12 are the mating threads between those of the travel member 245 and those of the lead screw 140. Other types of linear actuators may be employed, for example a linear actuator providing a vertically oriented lower housing within the interior 17 and operatively coupled to a horizontally directed upper housing containing the extension member. In such a configuration, the extension member 32 remains fixed along the linear axis 33 as the door 14 moves between the open and closed position.

In view of the above, the linkage 24 (e.g. control linkage with or without the track 42 provides for the extensible member 32 (e.g. the driven part of the spindle or actuator 26) to swing about a center point). This configured operation provides for the extensible member 32 to articulate about a pivot axis (e.g. about pivot point 28 and/or pivot point 34) which inhibits binding and provides for the door/lift gate (i.e. closure panel 14) to operate unhindered between the open and closed positions.

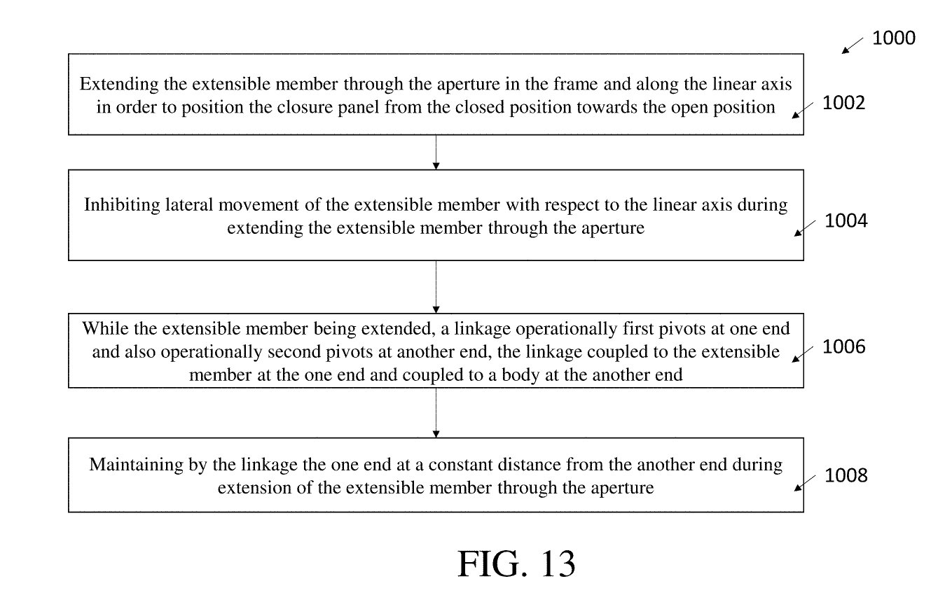

Referring to FIG. 13, shown is a method 1000 for operating the linear actuator assembly 30. At step 1002 the extensible member 32 is extended through the aperture 43 in the frame 15 and along the linear axis 33 in order to position to closure panel 14 from the closed position towards the open position. At step 1004, there is provided the inhibiting of lateral movement of the extensible member with respect to the linear axis during extending (and/or retraction) the extensible member through the aperture 43, for example by inhibiting lateral movement of the extensible member 32 using the sealing member 36 with respect to the linear axis 33. At step 1006, as the extensible member 32 is extended, the linkage 24 operationally first pivots at the one end 28′ and also operationally second pivots at the another end 34′, wherein both the one end 28′ and the another end 34′ are located externally to the interior 17 of the frame 15 and are both to one side of the aperture 34. The method 1000 may also include the step 1008 of maintaining by the linkage 24 the one end 28′ at a constant distance from the another end 34′ during extension (and/or retraction) of the extensible member 32 through the aperture.

A further embodiment is such that the linear actuator assembly 30 can be positioned in an interior 17 of the body 12. For example, the linear actuator assembly 30 for the closure panel 14 of the vehicle 10 comprising: a linear actuator 26 for mounting in the interior 17 of the body 12 of the vehicle 10 and having the extensible member 32 for extending through the aperture 43 in the body 12, the extensible member 32 configured for extension and retraction with respect to the interior 17 along the linear axis 33 of the linear actuator 26, the body 12 having the aperture 43 opposite a shut face 35 of the frame 15 of the closure panel 14; a sealing member 36 for positioning on the body 15 adjacent to the extensible member 32, and for inhibiting foreign matter from entering the interior 17 from an exterior of the body 12, the sealing member 36 inhibiting lateral movement of the extensible member 32 with respect to the linear axis 33; and the linkage 24 operationally first connecting at one end 28′ to the extensible member 32 and for operationally second connecting at another end 34′ to the frame 15, such that both the one end 28′ and the another end 34′ are located externally to the interior 17 of the body 12 being both to one side of the aperture 43.

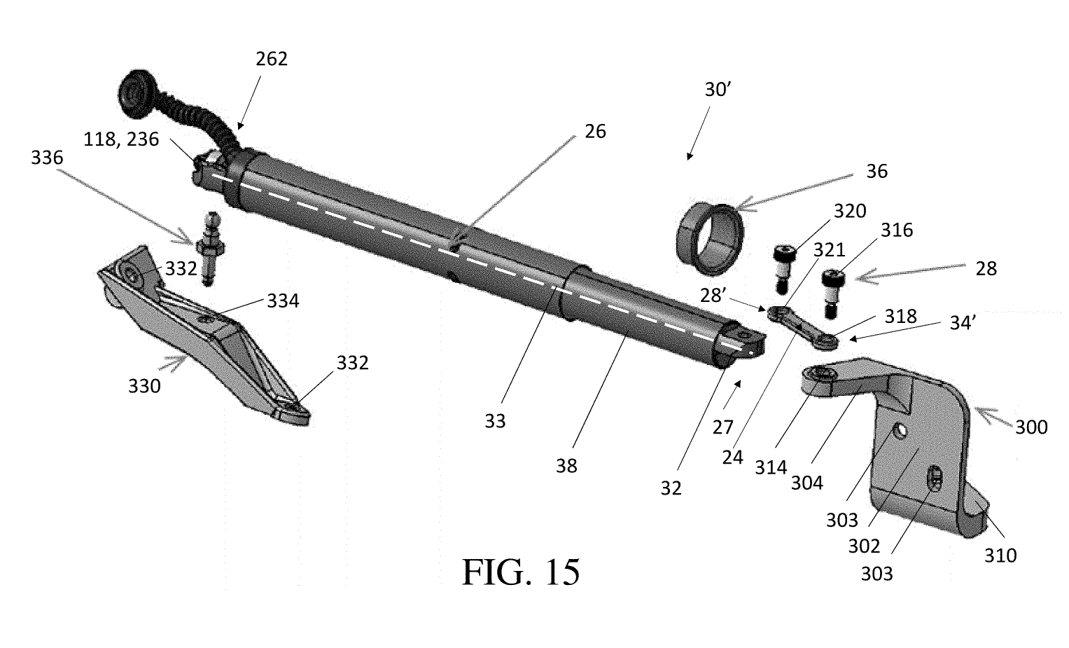

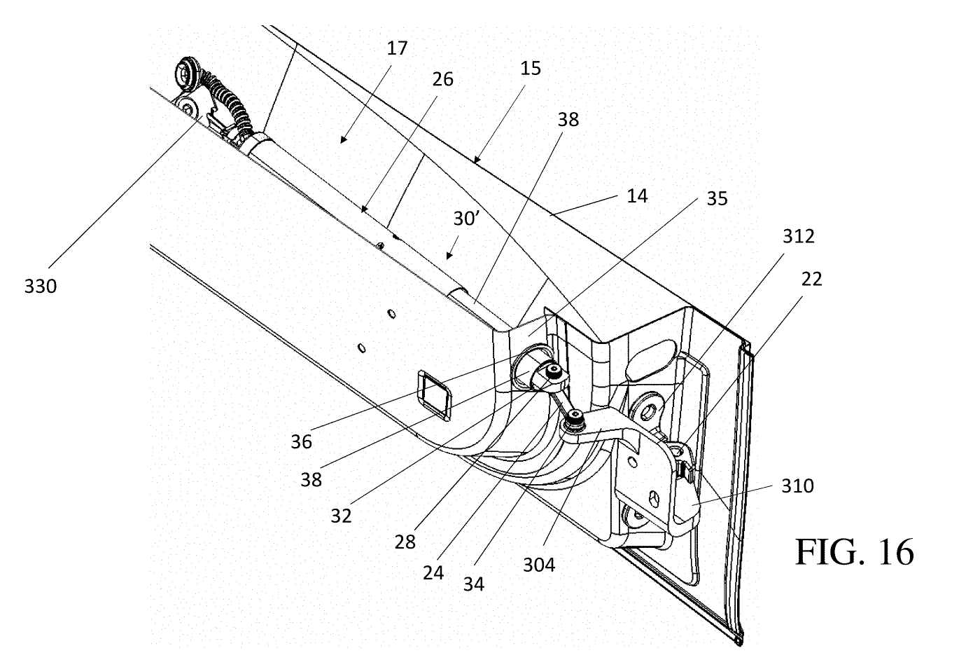

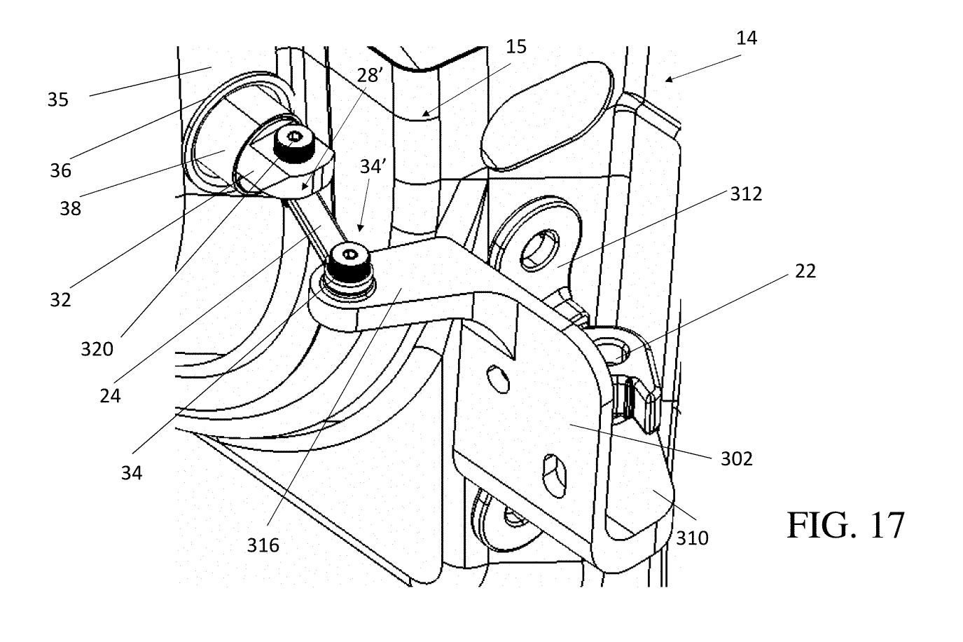

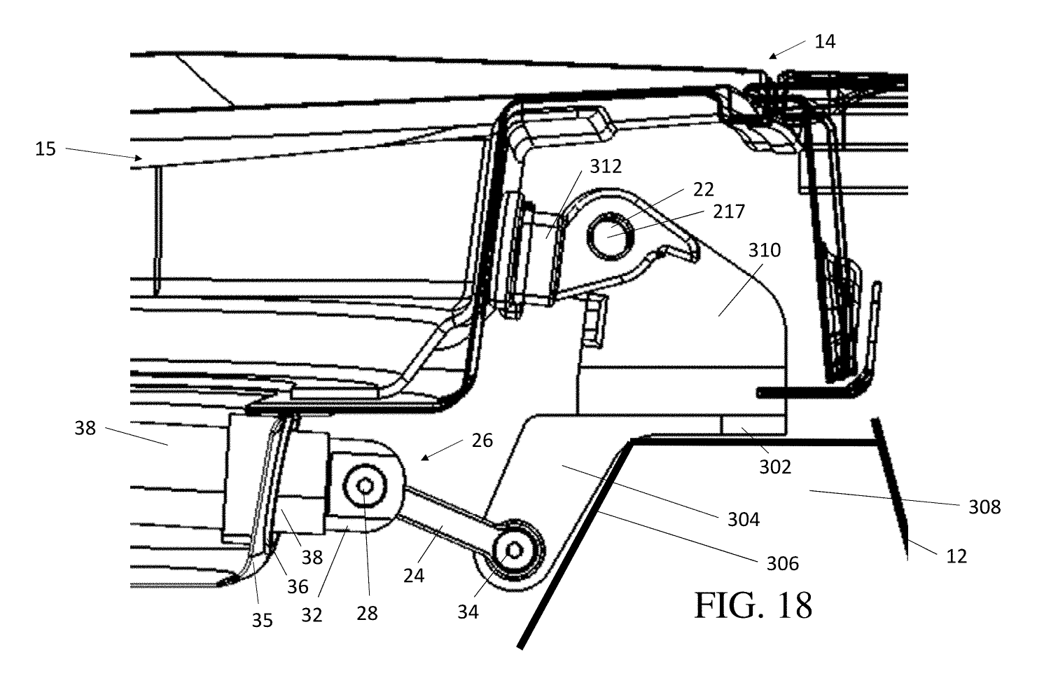

Now referring to FIGS. 15 to 18, there is illustrated an alternative embodiment of the linear actuator assembly 30′ including a body mounting bracket 300 including a body 302 for fixing to the vehicle body 12 using fasteners such as bolts or screws as is typically known, through mounting apertures 303. Connected to body 302 is an oppositely extending linkage mounting arm 304 projecting illustratively perpendicularly away from body 302 and parallel to a surface 306 of the pillar 308 of the vehicle body 12, and hinge mounting arm 310 for forming the body side portion of hinge 22 for pivotal connection with a door side hinge portion 312 of closure panel 14 to pivotal rotation of the closure panel 14. Linkage mounting arm 304 includes a mounting port or hole 314 for receiving a fastener, such as a first pivot pin 316 about first pivot point 34, with pivot pin 316 also extending through a first linkage aperture 318 within linkage 24 for coupling another end 34′ to linkage mounting arm 304. A second pivot pin 320 similarly coupling the one end 28′ of linkage 24 to the extensible member 32 through receipt within overlapping first pivot 28 and second linkage aperture 321. Door mounting bracket 300 provides an integral bracket assembly formed by stamping and bending for example, for coupling both the vehicle closure panel 14 and the linkage 24 thereto, such that the single door mounting bracket 300 is attachable to the vehicle body 12 as a single component. Linear actuator assembly 30′ also includes a door mounting bracket 330 illustratively fixed to frame 15 with fasteners (not shown) secured within mounting apertures 332 of door mounting bracket 330. Door mounting bracket 330 includes a connection point 334 for receiving part of a connector, such as a ball socket connector 336, also coupled to the fixed mount 118 of linear actuator 26 for fixedly securing second end 262 to the door frame 15.

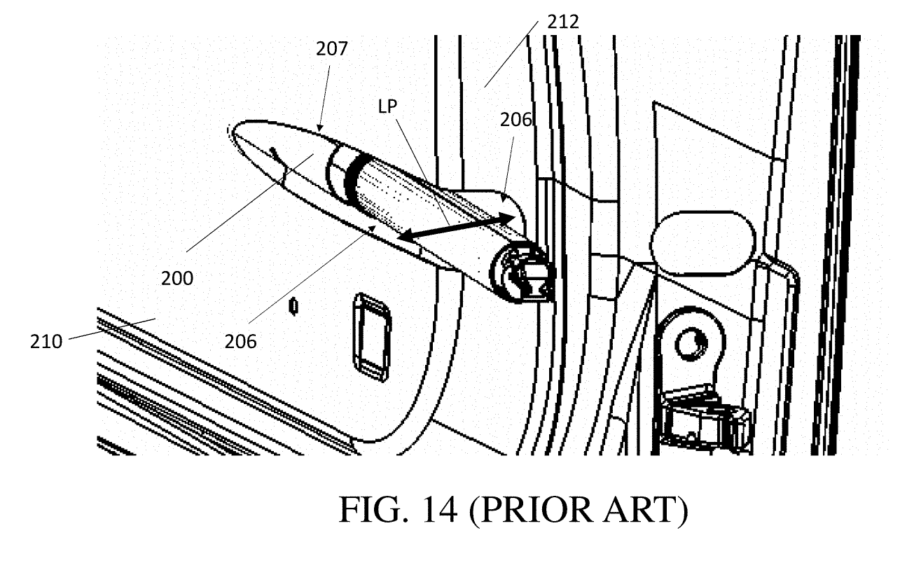

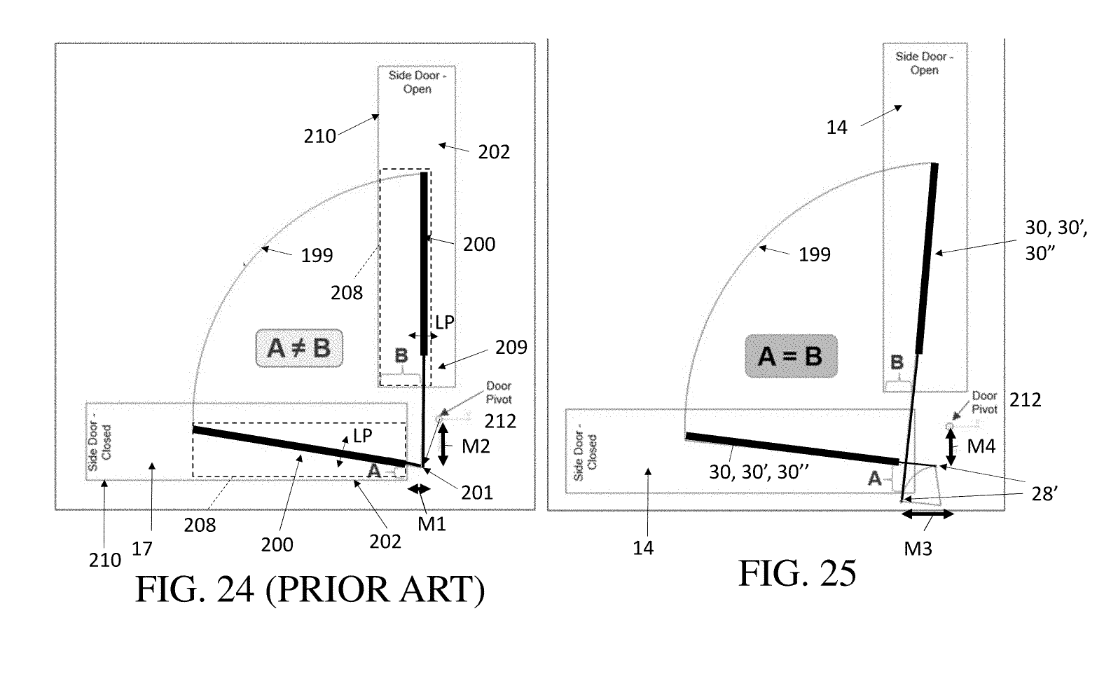

With reference to FIG. 24, illustrated is an example of a current state of the art linear actuator system, with such a system configured with the end of the spindle 200 directly and fixedly connected 201 to the vehicle frame. However, due to the offset point of rotation of the door 202 about the hinges, relative to this fixed connection point 201, the spindle 200 is typically allowed to have some lateral play LP, (e.g. pivotal) in its movement e.g. along a spindle door attachment wing path 199 internal to the door 202, in order for the door 202 not to jam. However, a further disadvantage of such a state of the art system is realized in that in order to accommodate this lateral play, an access port 206 (see FIG. 14) through the door frame 207 (e.g. inner panel 210, and/or shut face 212) (from which the spindle 200 extends) must be provided as larger than a diameter of the spindle 200. As a consequence, this enlarged access port 206 needs to have a seal (not shown), such as a rubber or silicon boot, that accounts for this allowed lateral movement LP, which can become an undesirable maintenance item due to age/wear. Also, dedicated internal space 208 within the door cavity 17 must be provided in order to accommodate for the lateral movement LP of current spindle designs. For example, spindle end 209 is at a distance A from the inner door panel 210 when the door 202 is in the fully closed position, whereas spindle end 209 is at a distance B, greater than A from the inner door panel 210 when the door 202 is in the fully open position. In particular, on narrow doors, this lateral movement of the state of the art linear actuator can lead to jamming or intrusion.

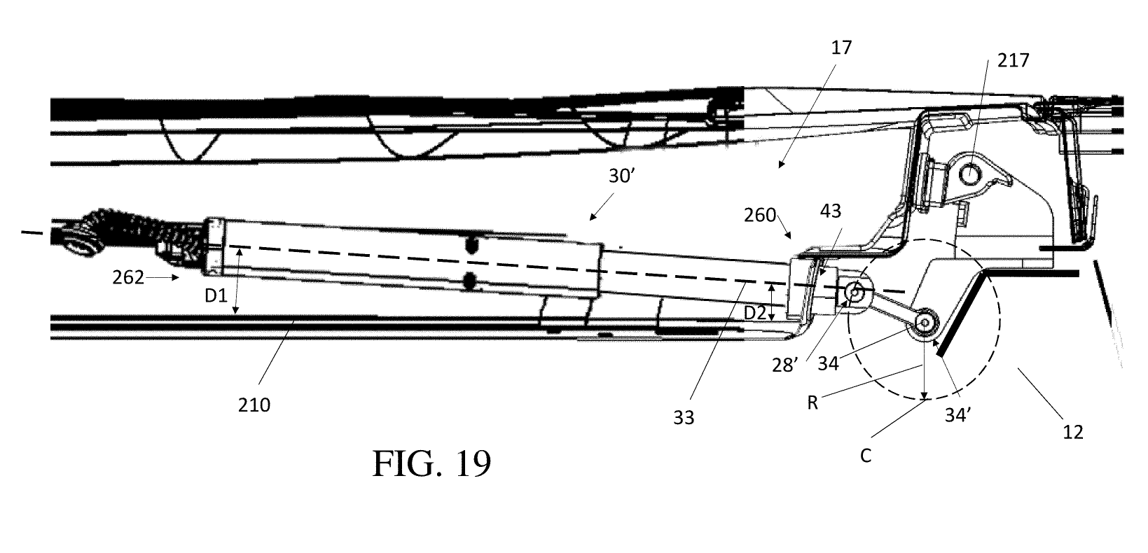

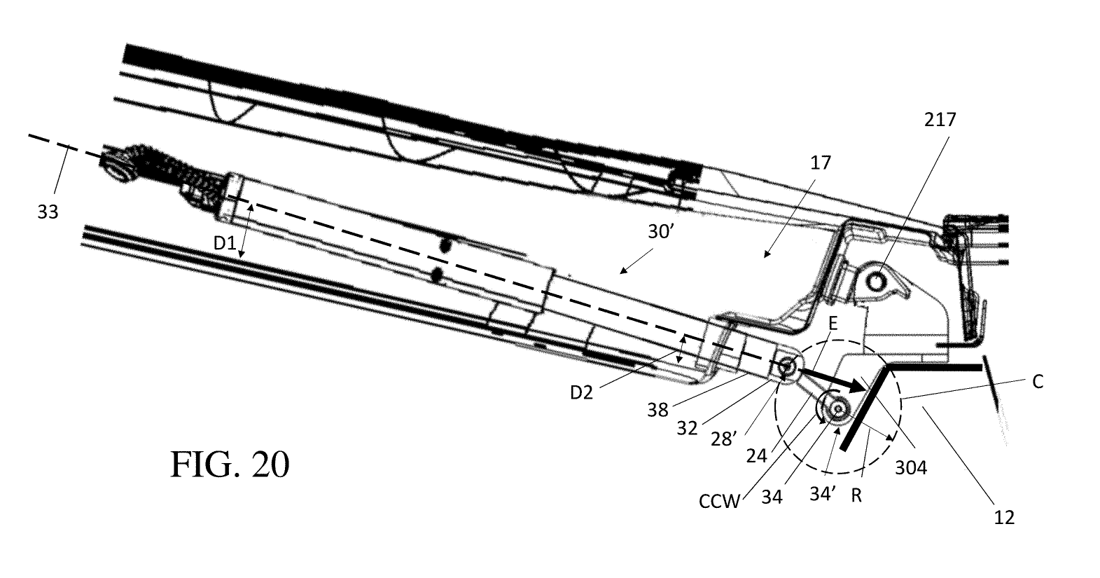

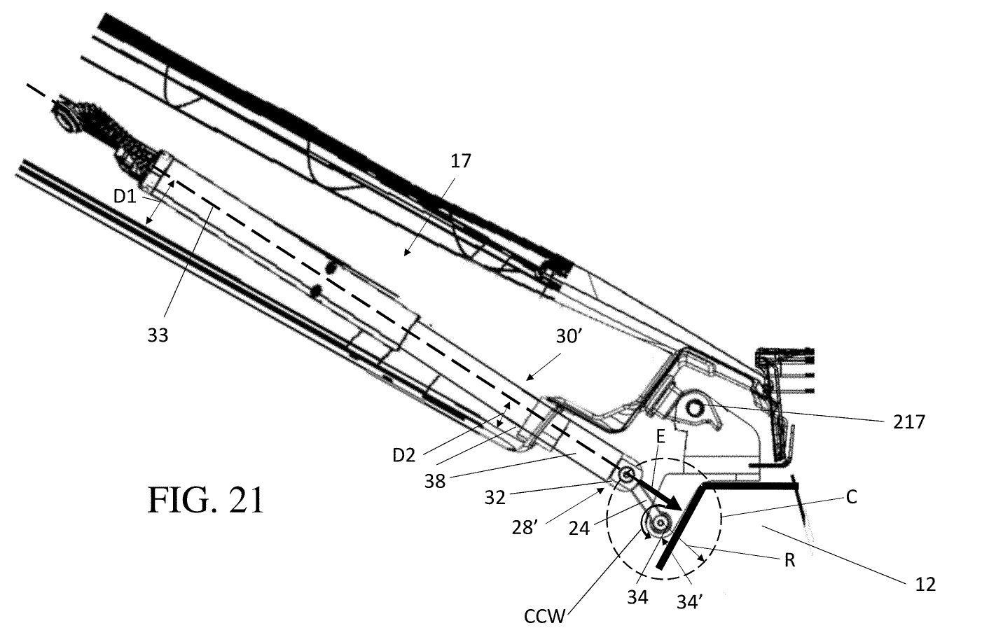

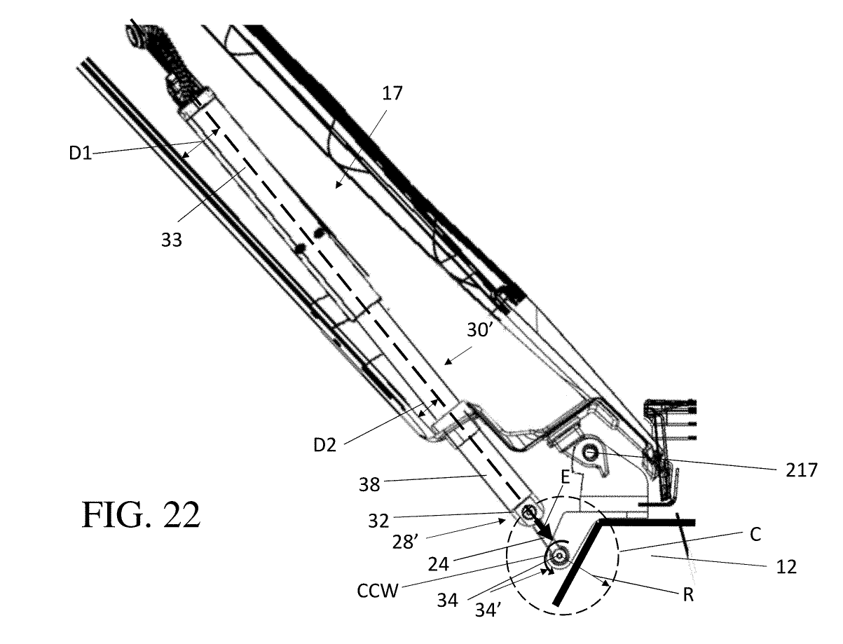

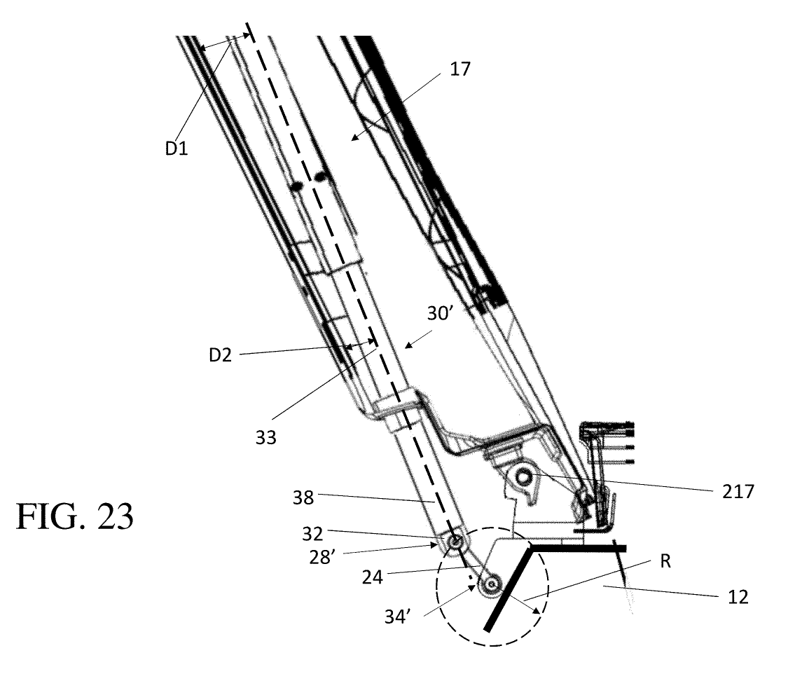

Now with reference to FIGS. 19 to 23, and FIG. 25, there is shown an illustrative operation of the linear actuator assembly 30′ installed between a vehicle body 12 and a vehicle door 14 (e.g. within interior 17 along linear axis 33). Illustratively, the linear actuator assembly 30′ is mounted at an angle within interior 17 of the door frame 15 relative to inner panel 210 such that second end 262 is mounted at a distance D1 relative to the inner panel 210 and at a second distance D2 away from the first end 260 proximate shut face 35 to define the constant linear axis 33 that does not vary or change as the door 14 moves between the closed position (FIG. 19) and the open position (FIG. 23) (e.g. D1 and D2 to not vary). As a result, extensible member 32 extends through the aperture 43 in the door frame 15, extends and retracts with respect to the interior 17 along the linear axis 33 of the linear actuator assembly 30′ during the closure panel 14 being moved between the closed position and the open position. As is shown in FIGS. 19 to 23, the one end 28′ of linkage 24 is confined by the another end 34′ of linkage 24 pivoting about second pivot 34 such that the one end 28′ remains at a constant distance R along a circular path C (e.g. one end 28′ can move clockwise or counterclockwise along circular path C) away from the second pivot 34 during the extensible member 32 extending and retracting causing the door 14 to move between the open and closed positions. As a result the extensible member 32 for extending through the aperture 43 in the door frame 15 is able to extend and retract with respect to the interior 17 along the fixed linear axis 33 and linear actuator assembly 30′ remains fixed without any lateral play within interior 17 interfering with any other door components (e.g. window module, carrier, window regulator motor, speakers etc.) and without any lateral play within aperture 43 thereby simplifying the sealing of the aperture 43 with a fixed seal e.g. a rubber O-ring, such the sealing member 36 also acts to inhibit lateral movement of the extensible member 32 thereby providing a mounting point of the linear actuator assembly 30′ to the shut face 35 opposite door mounting bracket 330 without requiring any hard to access fastening features or brackets within the interior 17 to fix the linear actuator assembly 30′ along the linear axis 33. It is recognized that distances D1 and D2 remain constant during the movement of the vehicle door 14 between the open and closed positions. Illustratively, as extensible member 32 extends as represent by Arrow E, linkage 24 is forced to rotate counterclockwise CCW. FIG. 25 diagrammatically shows the one end 28′ of linkage 24 allowed to move relative to the door pivot 217 to permit the linear actuator assembly 30′ to remain fixed along the linear axis 33 without any lateral play during the door 14 opening and closing, as compared to the prior art configuration having a spindle 200 mounted to a constant fixed connection point 201 resulting in lateral play LP and requiring a larger access port 206 to accommodate such lateral play, requiring complex sealing solutions. Also, moment arms M4 (at door closed position), and M3 (at door open position) of linear actuator assembly 30, 30′, 30″ remain constant or nearly constant, as compared to the moment arms M2 (at door closed position), and M1 (at door open position), where M2 is significantly greater than Ml.

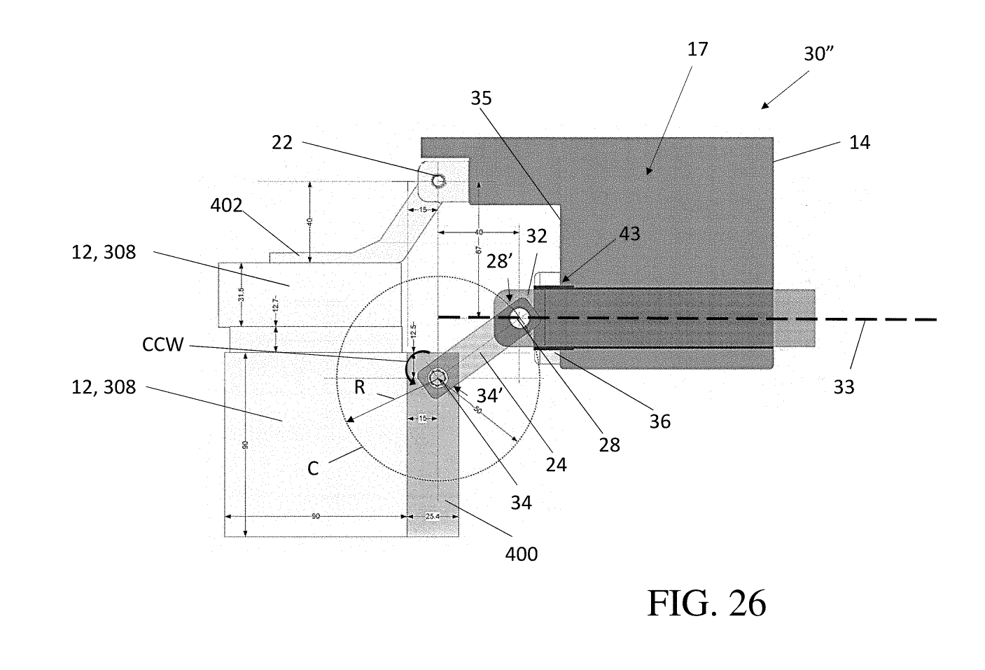

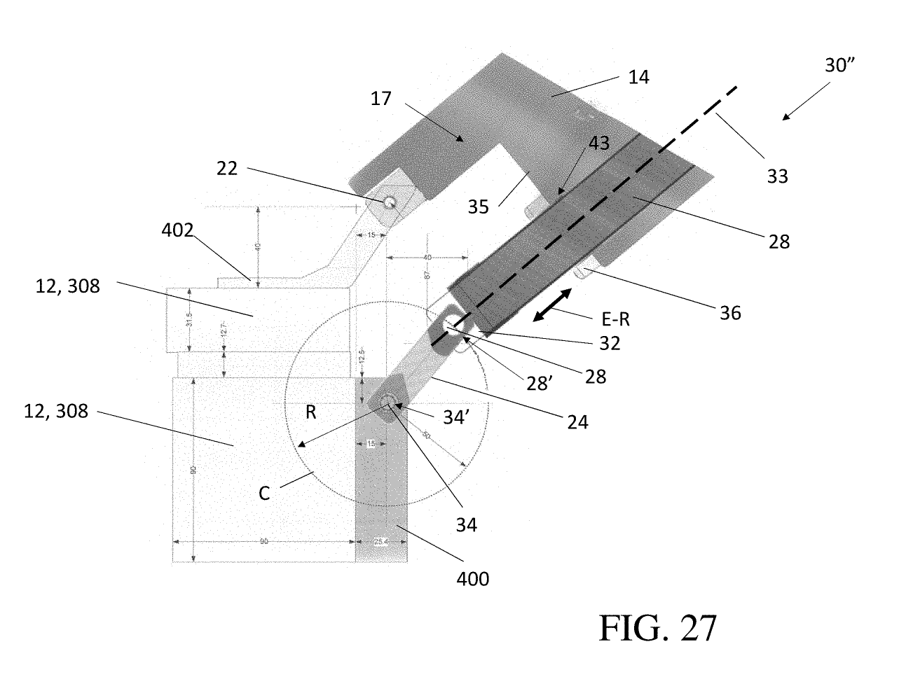

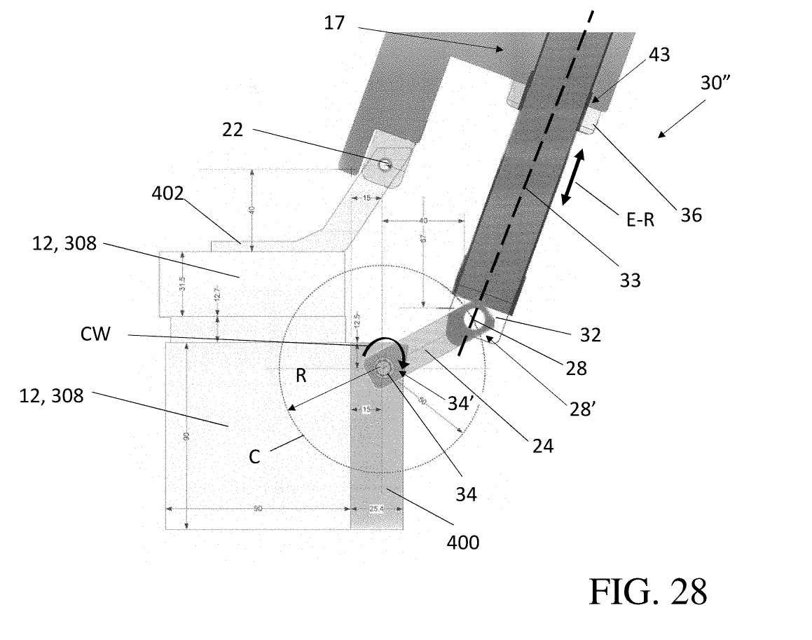

Now with reference to FIGS. 26 to 28, there is shown another illustrative operation of the linear actuator assembly 30″ installed between a vehicle body 12 and within a vehicle door 14. In the illustrated embodiment, one end 28′ of linkage 24 is fixed to the vehicle body 14 e.g. A-pillar 308 via a bracket 400 mounted to the vehicle body 12, while closure panel 14 is pivotally mounted to the vehicle body 12 via a separate hinge bracket assembly 402, fixed to vehicle body 12. Operation of linear actuator assembly 30″ is similar to other embodiments described hereinabove, and in particular, extensible member 32 extends through the aperture 43 in the door frame 15, extends and retracts E-R with respect to the interior 17 along the linear axis 33 of the linear actuator assembly 30″ during the closure panel 14 being moved between the closed position and the open position, the one end 28′ of linkage 24 is confined by the another end 34′ of linkage 24 pivoting about second pivot 34 such that the one end 28′ remains at a constant distance R along circular path C away from the second pivot 34 during the extensible member 32 extending and retracting causing the door 14 to move between the open and closed positions. As seen in FIG. 27, extension of extensible member 32 cause linkage 24 to rotate initially counterclockwise, and at a inflection point to cause linkage 24 to rotate in an opposite clockwise rotation as seen in FIG. 28 during continued extension of extensible member 32.

While the above description constitutes a plurality of embodiments, it will be appreciated that the present disclosure is susceptible to further modification and change without departing from the fair meaning of the accompanying claims.

We claim:

1. A linear actuator assembly (30) for a closure panel (14) of a vehicle (10) comprising:
a linear actuator (26) for mounting in an interior (17) of a frame (15) of the closure panel and having an extensible member (32) for extending through an aperture (43) in the frame, the extensible member configured for extension and retraction with respect to the interior along a linear axis (33) of the linear actuator, the frame having the aperture on a shut face (35); and
a linkage (24) operationally first connecting at one end (28′) to the extensible member and for operationally second connecting at another end (34′) to a body (12) of the vehicle adjacent to the closure panel.

2. The linear actuator assembly of claim 1, wherein said operationally first connecting is pivotally connected at a first pivot (28) and said operationally second connecting is pivotally connected at a second pivot (34), such that both the one end and the another end are located externally to the interior of the frame being both to one side of the aperture.

3. The linear actuator assembly of claim 1, wherein the linkage positions the one end (28′) at a constant distance from the another end (34′) during extension of the extensible member through the aperture, the extensible member (32) extends through the aperture without lateral movement of the extensible member with respect to the linear axis.

4. The linear actuator assembly of claim 1 having a housing cover (38) for supporting the extensible member on the shut face at the aperture and further comprising a sealing member (36) between the aperture and the housing cover.

5. The linear actuator assembly of claim 4, wherein the housing cover is movable relative to the sealing member during operation of the linear actuator for said extension and said retraction.

6. The linear actuator assembly of claim 4, wherein the housing cover is fixed relative to the sealing member during operation of the linear actuator for said extension and said retraction.

7. The linear actuator assembly of claim 1, wherein the linkage is of a linear shape between the one end and the another end.

8. The linear actuator assembly of claim 1, wherein the linear actuator (26) is fixedly mounted within the interior (17) along the linear axis (33) with respect to the interior of the closure panel, the extensible member (32) extending through the aperture (43) in the frame along the linear axis during the closure panel (14) moving between a closed position and an open position.

9. The linear actuator assembly of claim 1, wherein the linear actuator includes a lead screw coupled to the extensible member, such that rotation of the lead screw results in said extension and said retraction.

10. The linear actuator assembly of claim 1, wherein the closure panel is a swing door and the frame is connected to the body via one or more hinges.

11. The linear actuator assembly of claim 1, further comprising a sealing member (36) between the aperture and the extensible member for inhibiting foreign matter from entering the interior from an exterior of the frame, the sealing member inhibiting lateral movement of the extensible member with respect to the linear axis.

12. The linear actuator assembly of claim 2, wherein the linkage includes a plate (40) having a track therein, the track (42) in which the first pivot translates along a translation axis (44) of the track wherein said operationally first connecting is pivotally connected at a first pivot configured for translational movement along the track of the linkage and said operationally second connecting is connected at a second pivot.

13. The linear actuator assembly of claim 12, wherein the first pivot is a pin connection fitted with a roller to follow the track translation axis.

14. The linear actuator assembly of claim 13, wherein the pin connection includes both translation and rotation.

15. A method for operating a linear actuator assembly (30) for a closure panel (14) of a vehicle (10), the linear actuator assembly (30) having a linear actuator (26) for mounting in an interior (17) of a frame (15) of the closure panel and having an extensible member (32) for extending through an aperture (43) in the frame, the extensible member configured for extension and retraction with respect to the interior along a linear axis (33) of the linear actuator, the method including the steps of:
extending the extensible member through the aperture in the frame (15) and along the linear axis in order to position the closure panel (14) from a closed position towards an open position;
inhibiting lateral movement of the extensible member with respect to the linear axis during extending the extensible member through the aperture;
while the extensible member being extended, a linkage (24) operationally first pivots at one end (28′) and also operationally second pivots at another end (34′), the linkage coupled to the extensible member at the one end and coupled to a body at the another end; and
maintaining by the linkage the one end (28′) at a constant distance from the another end (34′) during extension of the extensible member through the aperture.

16. The method of claim 15, wherein the one end includes both said first pivots and translation along a path in a body of the linkage.

17. The method of claim 15 further comprising the step of retracting the extensible member into the interior via the aperture, wherein both the one end and the another end are located externally to the interior of the frame and are both to one side of the aperture.

18. The method of claim 15, wherein the linear actuator assembly has a housing cover (38) for supporting the extensible member on frame at the aperture, the method further comprising the steps of inhibiting lateral movement of the extensible member by positioning a sealing member positioned between the aperture and the housing cover, and moving the housing cover relative to the sealing member during said extending.

19. The method of claim 15, wherein the linear actuator assembly has a housing cover for supporting the extensible member on frame at the aperture, the method further comprising the steps of inhibiting lateral movement of the extensible member by positioning a sealing member between the aperture and the housing cover, and holding the housing cover fixed relative to the sealing member during said extending.

20. A linear actuator assembly (30) for a closure panel (14) of a vehicle (10) comprising:
a linear actuator (26) for mounting in an interior (17) of a body (12) of the vehicle and having an extensible member (32) for extending through an aperture (43) in the body, the extensible member configured for extension and retraction with respect to the interior along a linear axis (33) of the linear actuator, the body having the aperture opposite a shut face (35) of a frame (15) of the closure panel;
a sealing member (36) for positioning on the body adjacent to the extensible member for inhibiting foreign matter from entering the interior from an exterior of the body, the sealing member inhibiting lateral movement of the extensible member with respect to the linear axis; and
a linkage (24) operationally first connecting at one end (28′) to the extensible member and for operationally second connecting at another end (34′) to the frame (12), such that both the one end and the another end are located externally to the interior of the body being both to one side of the aperture.
